(19) United States
(12) Patent Application Publication
(10) Pub. No.: US 2009/0218732 A1
(43) Pub. Date: Sep. 3, 2009

(54) System and method for edge heating of stretch film

(76) Inventors: David Cron, Ho-Ho-Kus, NJ (US); William Harkey, Harrisburg, NC (US); David Rudd, South Hackensack, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/074,114

(22) Filed: Feb. 29, 2008

(51) Int. Cl. B29C 67/00

(52) U.S. Cl. 264/342 R; 425/383

(57) ABSTRACT

The present invention relates to a method and system for edge treatment of a film in which one or both edges of the film is heated to a temperature above a softening point of a DSC onset temperature. In one embodiment, the edges of film are heated to a temperature above the peak DSC temperature. A central portion of the film between the edges remains at a lower temperature. In one embodiment, an edge heat treatment apparatus having a heated channel is used to receive an edge portion of the film and heat the edge portion.

### BACKGROUND OF THE INVENTION

1. Field of the Invention

The present invention relates to a system and method for edge heating of stretch film to a predetermined temperature for shrinking the sides of the film, smoothing out a cut edge of the film and/or thickening the edge.

2. Description of Related Art

Various processes for making stretch film with reinforced edges are known. U.S. Pat. No. 5,531,393 describes a stretch film having folded edges applied. The roll of film is prestretched along the length thereof and the edges are folded so as to strengthen the edges. The film can be rolled to minimize the piling up of the folded edges.

U.S. Pat. No. 6,592,699 describes a process for making stretch film having heat-sealed edges. A folding apparatus folds the edge portions of a film to form folded edges. The folded film is then passed through a bridle mechanism having two heated rolls. The heated rolls are heated to a temperature in the range of 150° F. to about 250° F. The heated rolls heat the entire face of the film. The hot stretch process performs a dual process of stretching the film and heat sealing the folded edges.

The above-described patents have the disadvantage that the edge thickness is determined by doubling of thickness of the film by folding over the edge thereby requiring extra material. It is desirable to provide a method for more precisely controlling the edge thickness and reducing the amount of material needed for forming a thicker edge on the film.

### SUMMARY OF THE INVENTION

The present invention relates to a method and system for edge treatment of a film in which one or both edges of the film is heated to a temperature above a softening point of a DSC onset temperature. In one embodiment, the edges of film are heated to a temperature above the peak DSC onset temperature. A central portion of the film between the edges remains at a lower temperature. In one embodiment, an edge heat treatment apparatus having a heated channel is used to receive an edge portion of the film and heat the edge portion.

In one embodiment, the edge heat treatment apparatus is used before a pre-stretching of the film. A second heat treatment apparatus can be used after pre-stretching of the film.

The invention will be more fully described by reference to the following drawings.

### BRIEF DESCRIPTION OF THE DRAWINGS

FIG. 1 is a schematic diagram of a system for edge heating of stretch film in accordance with the teaching of the present invention.

FIG. 2 is a schematic diagram of an edge heat treatment apparatus receiving an edge of film.

FIG. 3 is a graph of an example DSC curve.

FIG. 4 is a schematic diagram of a top plan view of the system for edge heating of a stretched film.

FIG. 5 is a schematic side view of the film after heat treatment with the edge heat treatment apparatus.

FIG. 6 is a schematic diagram of a rough edge of an edge portion of the film.

FIG. 7 is a schematic diagram after heating the rough edge with the edge heat treatment apparatus to provide a smooth edge.

FIG. 8 is a schematic diagram of an alternate embodiment of an edge heat treatment apparatus.

FIG. 9 is a schematic diagram of a system for edge heating of a stretch film including pre-stretching.

FIG. 10 is a schematic diagram of a system for edge heating of a stretch film including a blade.

FIG. 11 is a schematic diagram of a roll of film including a thickened edge.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 1 is a schematic diagram of a system for edge heating of stretch film 10 in accordance with the teaching of the present invention. Film 12 is received over roller 14. For example, film 12 can be a stretchable plastic film manufactured by the blown film or as cast film process. Film 12 can be formed of one or more layers and/or blends having any known compositions such as, for example, polyethylene, linear low density polyethylene, very low density polyethylene, polyvinyl chloride, ethylene vinyl acetate, ethylene methyl acetate, ethylene methyl acrylate, metallocene linear low density polyethylene, high density polyethylene, polypropylene, enable metallocene polyethylene, and ethylene copolymers with high alpha olefins.

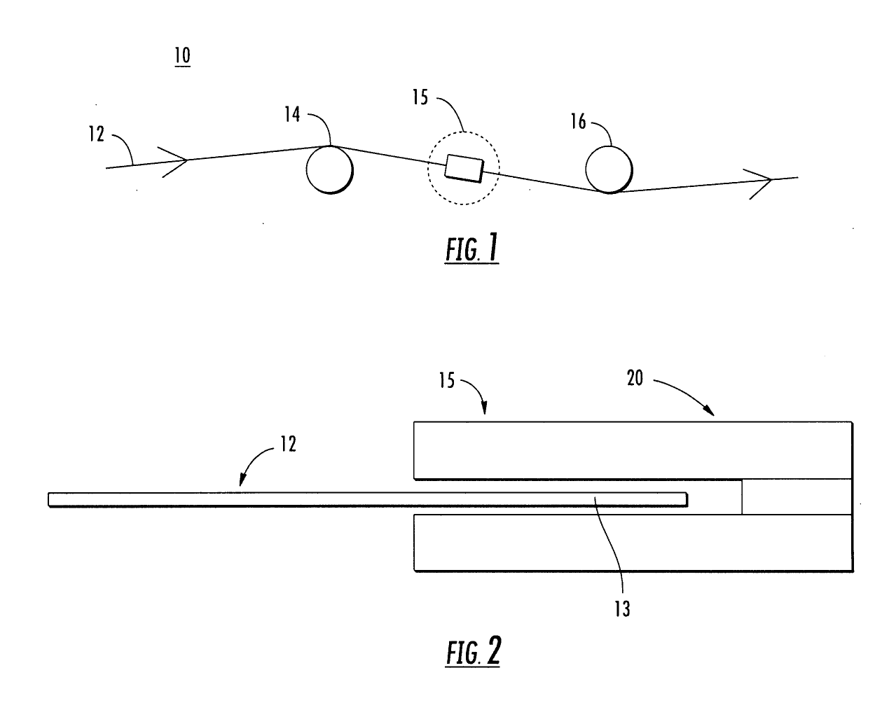

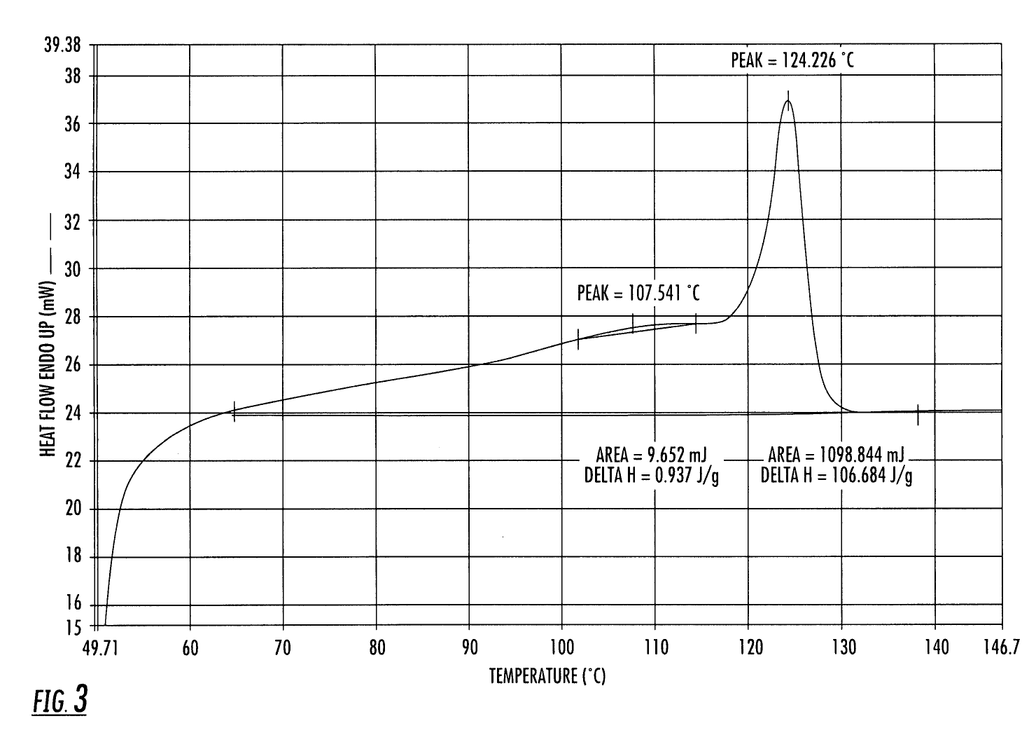

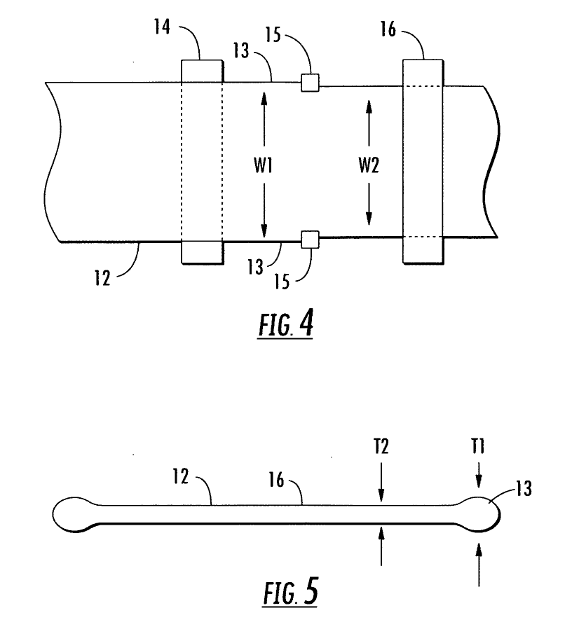

Film 12 is received in edge heat treatment apparatus 15. In one embodiment, edge heat treatment apparatus 15 comprises heated channel 20 which receives edge portion 13 of film 12, as shown in FIG. 2. Edge portion 13 is heated to a temperature above the onset point of the differential scanning calorimetry (DSC) and more preferably above the peak DSC temperature. An example DSC curve for a stretch film is shown in FIG. 3. For example, film 12 can be heated to a temperature in the range of about 120° C. to about 140° C. Film 12 can shrink upon reaching the peak DSC temperature for releasing internal stress in film 12.

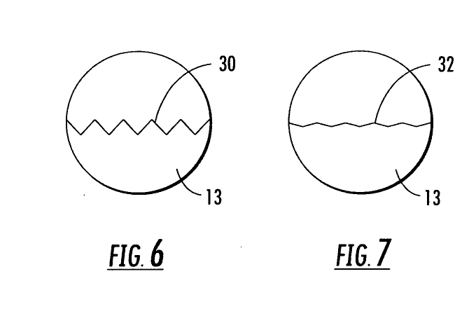

Heating film 12 with edge heat treatment apparatus 15 can increase the thickness of edge portion 13. Referring to FIG. 4, upon heating edge portion 13, with edge heat treatment apparatus 15, width W₂ is reduced from width W₁ before edge heat treatment apparatus 15 for shrinking film 12. For example, width of film 12 can be reduced in an amount in the range of about 1/32 to about ¼ inches. The reduction in width of film 12 results in an increase in edge thickness. For example after heating edge portion 13, has a thickness T₁ which is greater than a thickness T₂ of central portion 16 of film 12, as shown in FIG. 5. For example, the edge thickness T₁ can be increased by an amount in the range of about 10% to about 40%. After edge heat treatment apparatus 15, film 12 is received under roller 17, as shown in FIG. 1.

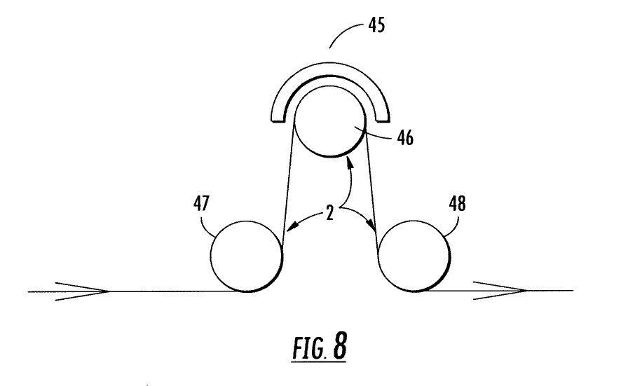

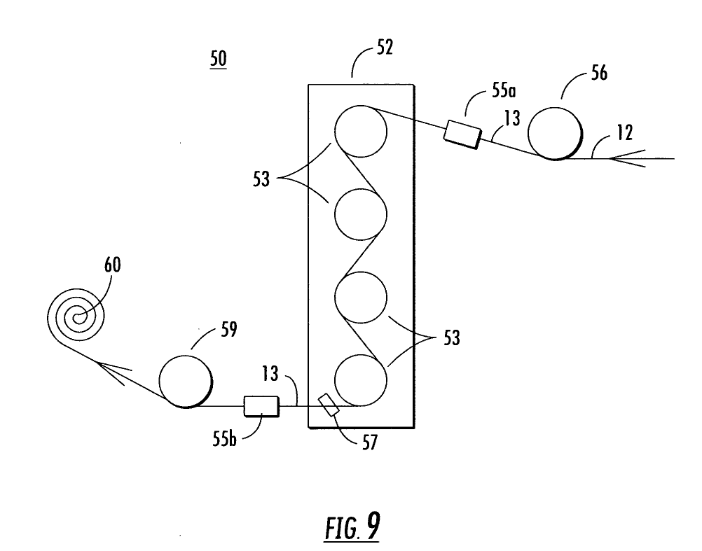

In one embodiment, edge portion 13 can have a rough edge 30 produced by slitting or cutting with a blade, as shown in FIG. 6. Upon heating rough edge 30 with edge heat treatment apparatus 15, rough edge 30 is smoothed out to form smooth edge 32, as shown in FIG. 7.

In an alternate embodiment, edge heat treatment apparatus 45 is mounted over roller 46, as shown in FIG. 8. Edge heat treatment apparatus 45 has a curved shape matching the shape of roller 46. Edge heat treatment apparatus heats edge portion 13 of film 12. Film 12 is received under roller 47. Film 12 proceeds to edge heat treatment apparatus 45. After edge heat treatment apparatus 45, film 12 is received under roller 48.

FIG. 9 is a schematic diagram of a system for edge heating of stretched film 50. System for edge heating of stretched film 50 includes pre-stretch apparatus 52. Pre-stretch apparatus 52 includes a plurality of rollers 53. Film 12 is received in edge heat treatment apparatus 55a after being rolled with roller 56. Edge portion 13 of film 12 is heated by edge heat treatment apparatus 55a before being received in pre-stretch apparatus 52 for providing a stronger edge of film 12 while film 12 is proceeding through pre-stretch apparatus 52, thereby reducing tearing and allowing a greater amount of pre-stretch.

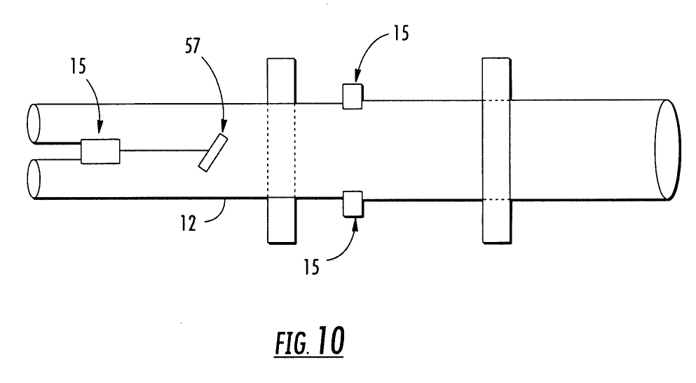

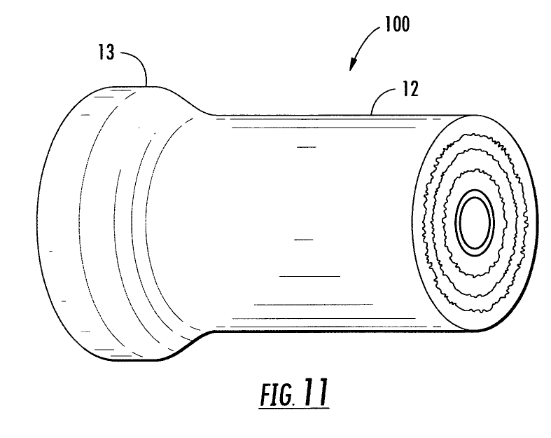

Blade 57 is used to cut film 12 for making two film webs, as shown in FIG. 10. Referring to FIG. 9, film 12 is received in edge heat treatment apparatus 55b after pre-stretch apparatus 52. Edge portion 13 of film 12 is heated by edge heat treatment apparatus 55b after pre-stretch apparatus 52 for increasing the strength of edge portion 13. Film 12 is rolled by roller 59 before being wound on roll 60.

In one embodiment, film 12 comprises multi-webs of film. Multi-web film 14 is received in edge heat treatment apparatus 15, edge heat treatment apparatus 45 or edge heat treatment apparatus 55. The multi-web of film can be slit with blade 57. The cut film is received in edge heat treatment apparatus 15, edge heat treatment apparatus 45 or edge heat treatment apparatus 55.

In one embodiment, film 12 comprises double wound sheeting. In an alternate embodiment, tubing 60 is used instead of film 12. Tubing 60 is received in edge heat treatment apparatus 15, edge heat treatment apparatus 45 or edge heat treatment apparatus 55.

FIG. 11 is a schematic diagram of roll 100 of film 12 including edge portion 13 having increased thickness.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for edge treatment of a film comprising the steps of:
heating one or both edges of said film to a temperature above a softening point of a DSC onset temperature wherein a portion of said film between said edges remains at a lower temperature than the heated one or both edges.

2. The method of claim 1 wherein said film is heated to a temperature above the peak DSC temperature.

3. The method of claim 1 further comprising the step of:
rolling said film before said step of heating one or both edges of said film.

4. The method of claim 1 further comprising the step of:
rolling said film after said step of heating one or both edges of said film.

5. The method of claim 1 wherein said film edge is heated to a temperature in the range of about 120° C. to about 140° C.

6. The method of claim 1 wherein after the heating step said one or both edges have an increased edge thickness.

7. The method of claim 6 wherein the edge thickness is increased an amount in the range of about 10% to about 40%.

8. The method of claim 1 after the heating step the step further comprising of pre-stretching said film.

9. The method of claim 8 after the pre-stretching step further comprising the step of:
second heating of one or both edges of said film to a temperature above a softening point of a DSC onset temperature.

10. The method of claim 9 further comprising the step of rolling said film after said step of second heating of one or both edges of said film.

11. The method of claim 1 after said pre-stretching step further comprising the step of cutting said film.

12. The method of claim 11 wherein said film is cut into two film webs.

13. A system for edge treatment of a film comprising:
means for heating one or both edges of said film to a temperature above a softening point of a DSC onset temperature wherein a portion of said film between said edges remains at a lower temperature than the heated one or both edges.

14. The system of claim 13 wherein said film is heated to a temperature above the peak DSC temperature.

15. The system of claim 13 further comprising:
means for rolling said film before said means for heating said one or both edges of said film.

16. The system of claim 13 further comprising:
means for rolling said film after said means for heating one or both edges of said film.

17. The system of claim 13 wherein said film is heated to a temperature in the range of about 110° C. to about 160° C.

18. The system of claim 13 further comprising after said means for heating means for pre-stretching said film.

19. The system of claim 17 further comprising:
means for second heating of one or both edges of said film to a temperature above a softening point of a DSC onset temperature after pre-stretching of said film.

20. The system of claim 13 further comprising means for rolling said film after said means for second heating of one or both edges of said film.

21. The system of claim 13 further comprising means for cutting said film.

22. The system of claim 13 wherein said film is a multi-web film.

23. The system of claim 14 wherein said film is double wound sheeting.

24. The system of claim 14 wherein said film is in the form of tubing.

25. The system of claim 13 wherein the means for heating comprises a heated channel, wherein said heated channel receives said edge of said film.
